(19) United States
(12) Patent Application Publication
(10) Pub. No.: US 2024/0383623 A1
(43) Pub. Date: Nov. 21, 2024

(54) SATELLITE WATCHING SYSTEM, SATELLITE INFORMATION TRANSMISSION SYSTEM, WATCHING SATELLITE, INFRASTRUCTURE SATELLITE, BIDIRECTIONAL COMMUNICATION STANDARD TERMINAL, WATCHING CENTER, DATA RELAY SATELLITE, CISLUNAR DATA RELAY SATELLITE, AND FREIGHTER

(71) Applicant: Mitsubishi Electric Corporation, Tokyo (JP)

(72) Inventor: Hisayuki MUKAE, Tokyo (JP)

(73) Assignee: Mitsubishi Electric Corporation, Tokyo (JP)

(21) Appl. No.: 18/689,090

(22) PCT Filed: Sep. 22, 2022
(86) PCT No.: PCT/JP2022/035328

§ 371 Date: Mar. 5, 2024

(30) Foreign Application Priority Data
Sep. 30, 2021 (JP) 2021-160609

(51) Int. Cl. B64G 3/00; B64G 1/10; H04B 7/185

(52) U.S. Cl. CPC B64G 3/00; B64G 1/1007; H04B 7/1851

(57) ABSTRACT

A satellite watching system exchanges watching information with a lunar and planetary exploration satellite, when a watching satellite passes through a vicinity of the lunar and planetary exploration satellite, and the lunar and planetary exploration satellite exchanges the watching information with a watching center via the cislunar data relay satellite. Each satellite in an infrastructure satellite cluster and a watching satellite cluster includes a bidirectional communication standard terminal with a transmission/reception switching device. The watching center operates the transmission/reception switching device, based on a data amount α of commands that are transmitted to the watching satellite and a data amount β of watching data and telemetry data that are received from the watching satellite, so that a ratio between reception time and transmission time of the watching satellite becomes α versus β, and carries out exchange of information with the watching satellite cluster via the lunar and planetary exploration satellite.

### TECHNICAL FIELD

The present disclosure relates to a satellite watching system, a satellite information transmission system, a watching satellite, an infrastructure satellite, a bidirectional communication standard terminal, a watching center, a data relay satellite, a cislunar data relay satellite, and a freighter.

### BACKGROUND ART

Satellite-based social infrastructures, such as information exchange with distant or frontier areas via communication satellites, weather forecasting using images from the Himawari weather satellite, and utilization of geospatial information from quasi-zenith positioning satellites, have been established in social life. These applications satellite groups have become critical infrastructures that are indispensable to the social life.

Meanwhile, due to factors such as debris collisions caused by increase in number of objects in space environment, hazardous events with risks of failure or loss of the critical infrastructures have been increasing.

Therefore, mechanisms to watch the critical infrastructures and to take danger avoidance actions, if necessary, have been required.

Patent Literature 1 discloses a method for observing space debris.

### CITATION LIST

### Patent Literature

Patent Literature 1: JP 2011-218834 A

### SUMMARY OF INVENTION

### Technical Problem

Patent Literature 1 does not disclose a method for exchanging data obtained from observation between cislunar space and ground without depending on weather.

An object of the present disclosure is to enable exchange of data obtained from watching the critical infrastructures between the cislunar space and the ground without depending on weather.

### Solution to Problem

A satellite watching system according to the present disclosure includes:
a critical infrastructure including an infrastructure satellite cluster including infrastructure satellites to fly in a cislunar space that is a space between the moon and the earth or beyond the moon, to form social infrastructure, and to put a service into practice;
a watching satellite cluster including watching satellites to fly between the moon and the earth to monitor the critical infrastructure and to provide an on-orbit service;
a ground installation installed on ground to exchange information with the infrastructure satellite cluster and to operate the infrastructure satellite cluster; and
a watching center installed on the ground to exchange information with the watching satellite cluster, wherein
the infrastructure satellite cluster includes a cislunar data relay satellite to relay communication between a space object flying in a near-moon orbit and the ground, and
when the watching satellite passes through a vicinity of a lunar and planetary exploration satellite having a consolidated environment of communication with the cislunar data relay satellite, as the critical infrastructure, the watching satellite exchanges watching information with the lunar and planetary exploration satellite, which exchanges the watching information with the watching center via the cislunar data relay satellite.

### Advantageous Effects of Invention

According to the satellite watching system of the present disclosure, data obtained from watching the critical infrastructures in the cislunar space or beyond the moon can be exchanged between the cislunar space and the ground without depending on weather.

### BRIEF DESCRIPTION OF DRAWINGS

FIG. 1 is a diagram illustrating an overall configuration example of a satellite watching system according to Embodiment 1.

FIG. 2 is a diagram illustrating a configuration example of a watching center according to Embodiment 1.

FIG. 3 is a diagram illustrating a configuration example of a satellite according to Embodiment 1.

FIG. 4 is a diagram illustrating Example 1 of a communication scheme in the satellite watching system according to Embodiment 1.

FIG. 5 is a diagram illustrating a configuration example of Example 1 of the communication scheme in the satellite watching system according to Embodiment 1.

FIG. 6 is a diagram illustrating another example of Example 1 of the communication scheme in the satellite watching system according to Embodiment 1.

FIG. 7 is a diagram illustrating a configuration example of Example 2 of a communication scheme in the satellite watching system according to Embodiment 1.

FIG. 8 is a diagram illustrating Example 2 of the communication scheme in the satellite watching system according to Embodiment 1.

FIG. 9 is a diagram illustrating a configuration example in which communication is carried out with a lunar and planetary exploration satellite regarded as a data relay satellite and with a watching satellite regarded as a user satellite, according to Embodiment 1.

FIG. 10 is a diagram illustrating a configuration example in which communication is carried out with the lunar and planetary exploration satellite and a gateway regarded as data relay satellites and with the watching satellite regarded as the user satellite, according to Embodiment 1.

FIG. 11 is a diagram illustrating a configuration example in which communication is carried out with the gateway regarded as the data relay satellite and with the lunar and planetary exploration satellite regarded as the user satellite, according to Embodiment 1.

FIG. 12 is a diagram illustrating a configuration example in which communication is carried out with the gateway regarded as the data relay satellite and with the lunar and planetary exploration satellite regarded as the user satellite, meanwhile, with the lunar and planetary exploration satellite regarded as the data relay satellite and with the watching satellite regarded as the user satellite, according to Embodiment 1.

FIG. 13 is a diagram illustrating a communication scheme in the satellite watching system according to Embodiment 1.

FIG. 14 is a diagram illustrating a communication scheme in a satellite information transmission system according to Embodiment 1.

FIG. 15 is a diagram illustrating a configuration example of a satellite watching system according to Modification 1 of Embodiment 1.

FIG. 16 is a diagram illustrating an example of a communication scheme in a satellite watching system according to Embodiment 2.

FIG. 17 is a diagram illustrating another example of a communication scheme in the satellite watching system according to Embodiment 2.

FIG. 18 is a diagram illustrating a background in which a data relay satellite according to Embodiment 3 is used.

FIG. 19 is a diagram illustrating a configuration example of the data relay satellite according to Embodiment 3.

FIG. 20 is a diagram illustrating an example of transmission with use of the data relay satellite according to Embodiment 3.

FIG. 21 is a diagram illustrating an example of transmission with use of the data relay satellite according to Embodiment 3.

FIG. 22 is a diagram illustrating a configuration example of a data relay satellite according to Modification 2 of Embodiment 3.

### DESCRIPTION OF EMBODIMENTS

Hereinbelow, embodiments of the present disclosure will be described with use of the drawings. Incidentally, in the drawings, identical portions or corresponding portions are provided with identical reference characters. In description on the embodiments, description on the identical portions or the corresponding portions is omitted or simplified appropriately. Further, relation among sizes of configurations in the following drawings may be different from actual relation. Further, in the description on the embodiments, directions or positions such as “upper”, “lower”, “left”, “right”, “fore”, “rear”, “front”, or “back” may be designated. Those expressions are given only for convenience of description and do not restrict placement and orientations of configurations such as devices, instruments, or components.

### Embodiment 1

### Description of Configuration

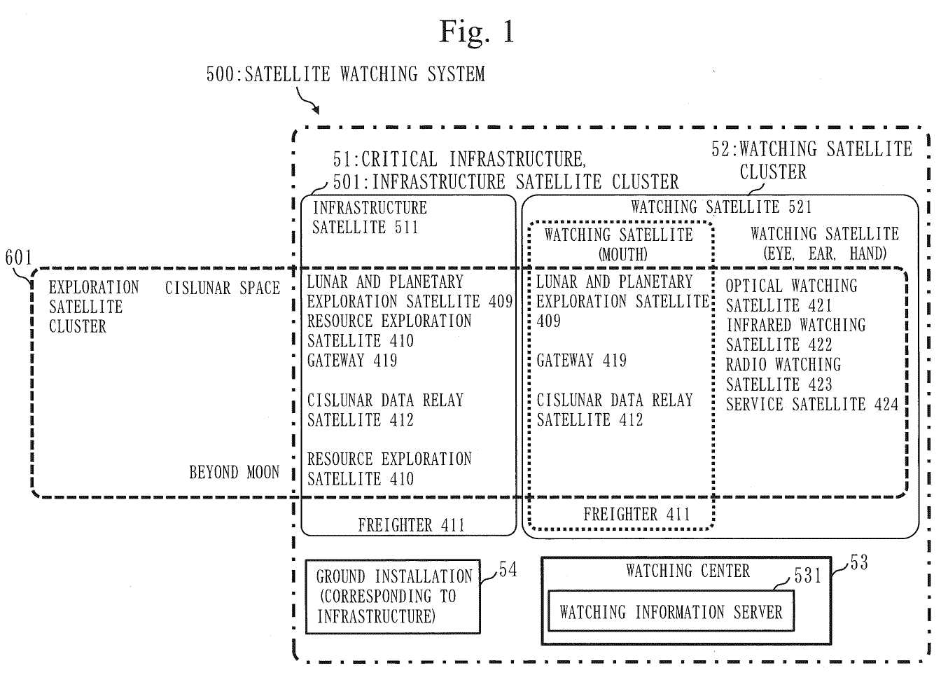

FIG. 1 is a diagram illustrating a configuration example of a satellite watching system 500 according to the present embodiment.

In the present embodiment, the satellite watching system 500 includes an exploration satellite cluster 601 and a watching center 53. The satellite watching system 500 may include ground installations 54.

The exploration satellite cluster 601 is a satellite cluster to fly in cislunar space that is space between the moon and the earth or beyond the moon. The exploration satellite cluster 601 includes a critical infrastructure 51 and a watching satellite cluster 52 including watching satellites 521 to monitor the critical infrastructure 51.

Incidentally, the watching satellites 521 may be referred to as monitoring satellites or monitoring devices.

The critical infrastructure 51 is social infrastructure in outer space. Specifically, the critical infrastructure 51 forms the social infrastructure such as exchange of information with distant or frontier areas via communication satellites.

The critical infrastructure 51 flies in the cislunar space that is the space between the moon and the earth or beyond the moon, forms the social infrastructure, and puts services into practice. The critical infrastructure 51 includes an infrastructure satellite cluster 501 including infrastructure satellites 511.

Further, the infrastructure satellites 511 may be referred to as critical infrastructure constituting satellites.

The infrastructure satellites 511 include satellites such as a lunar and planetary exploration satellite 409, a resource exploration satellite 410, a cislunar data relay satellite 412, and a gateway 419. Further, a freighter 411 to fly in the cislunar space or beyond the moon is included therein.

The cislunar data relay satellite 412 is a data relay satellite to relay communication between a space object flying in a near-moon orbit and the ground.

As the critical infrastructure 51, the freighter 411 is an example of a cislunar freighter which has a consolidated environment of communication with the cislunar data relay satellite 412 and transports commodities to the cislunar space.

The watching satellite cluster 52 includes the watching satellites 521. The watching satellites 521 fly between the moon and the earth to monitor the critical infrastructure 51 and to provide on-orbit services.

Watching services by the watching satellite cluster 52 can be easily understood by analogy with roles of eye, ear, hand, and mouth.

The watching satellites 521 that implement the role of mouth include satellites such as the lunar and planetary exploration satellite 409, the cislunar data relay satellite 412, and the gateway 419. Further, the freighter 411 to fly in the cislunar space or beyond the moon is included therein.

The watching satellites 521 that implement the role of eye, ear, or hand include satellites such as an optical watching satellite 421, an infrared watching satellite 422, a radio watching satellite 423, and a service satellite 424.

The ground installations 54 are installed on the ground, exchange information with the infrastructure satellite cluster 501, and operate the infrastructure satellite cluster 501. The ground installations 54 are ground installations corresponding to the respective infrastructures and may be referred to as infrastructure-corresponding ground installations.

The watching center 53 is installed on the ground and exchanges information with the satellites of the watching satellite cluster 52. The watching center 53 exchanges watching information 590 with the satellites of the watching satellite cluster 52. The watching center 53 includes a watching information server 531.

As described above, the watching services by the watching satellite cluster 52 can be easily understood by the analogy with the roles of eye, ear, hand, and mouth. In order to realize a purpose of visually watching the critical infrastructures 51 with an eye using a satellite, a method of visually monitoring a suspicious object such as debris with use of an optical telescope or radar images is effective. Further, a method of monitoring an abnormal temperature environment by infrared detection is also effective.

Further, the watching service of auditory watching with an ear has a purpose of monitoring radio waves in the outer space where sound waves do not propagate. In order to realize a purpose of auditorily watching the critical infrastructures 51 with an ear using a satellite, a method of receiving radio waves flying around and monitoring a condition of radio waves that may cause a malfunction is effective.

Further, as extension services of the watching, on-orbit services corresponding to the role of operating with a hand can be cited. The on-orbit services include services such as capture, inspection, and repair of a failed satellite. Further, the on-orbit services include services such as refueling to a satellite with fuel scarcity, a transfer service of moving a service position, and active debris removal (ADR) of a satellite that is unable to deorbit by itself after completing a lifetime thereof. Further, a service of monitoring a distance from a suspicious object such as debris through irradiation with laser is also included.

Thus, the watching satellites 521 are expected to realize the roles of eye, ear, or hand.

The role of mouth, that is, communication means for transmitting the watching information 590, however, is restricted and ingenuity is required therefor.

Examples of communication schemes in the satellite watching system 500 according to the present embodiment will be described later.

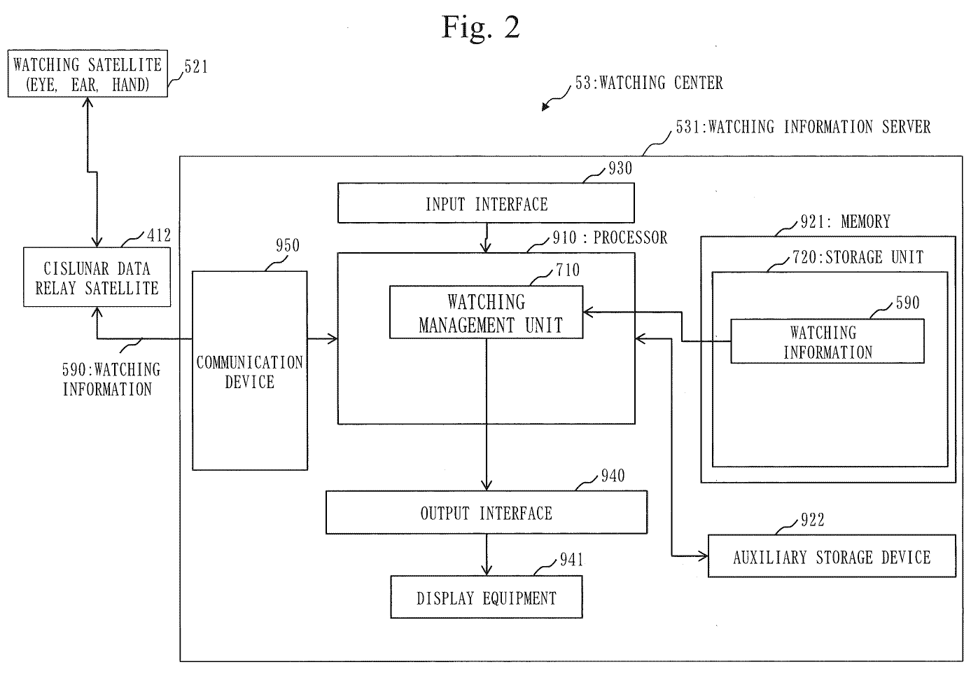

FIG. 2 is a diagram illustrating a configuration example of the watching center 53 according to the present embodiment.

The watching center 53 includes the watching information server 531. The watching information server 531 is a computer.

The watching information server 531 includes a processor 910 and further includes other pieces of hardware such as a memory 921, an auxiliary storage device 922, an input interface 930, an output interface 940, and a communication device 950. The processor 910 is connected to other pieces of hardware through signal lines in order to control other pieces of hardware.

The watching information server 531 includes a watching management unit 710 and a storage unit 720 as examples of functional elements, for instance. The watching information 590 is stored in the storage unit 720.

Functions of the watching management unit 710 are implemented by software. The storage unit 720 is included in the memory 921. Alternatively, the storage unit 720 may be included in the auxiliary storage device 922. Further, the storage unit 720 may be separated to be included in the memory 921 and the auxiliary storage device 922.

The watching information server 531 exchanges the watching information 590 with the watching satellites 521 via the cislunar data relay satellite 412 that is the infrastructure satellite 511, for instance. The watching management unit 710 realizes functions of coping with the risk of failure or loss of the critical infrastructures 51 with use of the watching information 590 exchanged with the watching satellites 521. For instance, the watching management unit 710 realizes the functions such as hazard warning, hazard prevention, and danger avoidance in the critical infrastructures 51.

The processor 910 is a device to execute a watching management program. The watching management program is a program to implement functions of components of the watching information server 531 and the watching center 53.

The processor 910 is an IC to carry out arithmetic processing. A specific example of the processor 910 is a CPU, a DSP, or a GPU. IC is an abbreviation for Integrated Circuit. CPU, which is the specific example of the processor 910, is an abbreviation for Central Processing Unit. DSP is an abbreviation for Digital Signal Processor. GPU is an abbreviation for Graphics Processing Unit.

The memory 921 is a storage device to temporarily store data. A specific example of the memory 921 is an SRAM or a DRAM. SRAM is an abbreviation for Static Random Access Memory. DRAM is an abbreviation for Dynamic Random Access Memory.

The auxiliary storage device 922 is a storage device to archive data. A specific example of the auxiliary storage device 922 is an HDD. Further, the auxiliary storage device 922 may be a portable storage medium such as SD (registered trademark) memory card, CF, NAND flash, flexible disc, optical disc, compact disc, Blu-ray (registered trademark) disc, or DVD. Here, HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

The input interface 930 is a port to be connected to an input device such as a mouse, a keyboard, or a touch panel. Specifically, the input interface 930 is a USB terminal. Incidentally, the input interface 930 may be a port to be connected to LAN. USB is an abbreviation for Universal Serial Bus. LAN is an abbreviation for Local Area Network.

The output interface 940 is a port to which a cable of display equipment 941 such as a display is to be connected. Specifically, the output interface 940 is a USB terminal or an HDMI (registered trademark) terminal. Specifically, the display is an LCD. HDMI (registered trademark) is an abbreviation for High Definition Multimedia Interface. LCD is an abbreviation for Liquid Crystal Display.

The communication device 950 includes a receiver and a transmitter. Specifically, the communication device 950 is a communication chip or an NIC. NIC is an abbreviation for Network Interface Card.

The watching management program is read into the processor 910 and is executed by the processor 910. In the memory 921, not only the watching management program but also an OS (Operating System) is stored. OS is an abbreviation for Operating System. The processor 910 executes the watching management program while executing the OS. The watching management program and the OS may be stored in an auxiliary storage device. The watching management program and the OS that are stored in the auxiliary storage device are loaded into the memory 921 and are executed by the processor 910. Incidentally, a potion or the whole of the watching management program may be integrated into the OS.

The watching information server 531 may include a plurality of processors that substitute for the processor 910. The plurality of processors share execution of the watching management program. Each of the processors is a device to execute the watching management program, as with the processor 910.

Data, information, signal values, and variable values that are utilized, processed, or outputted by the watching management program are stored in the memory 921, the auxiliary storage device 922, or a register or a cache memory in the processor 910.

The “unit” of the watching management unit 710 may be read as “processing”, “procedure”, or “step”. Further, the “processing” of watching management processing may be read as “program”, “program product”, or “computer-readable storage medium having a program recorded therein”.

The watching management program causes the computer to execute each processing, each procedure, or each step that results from reading of “unit” of the watching management unit as “processing”, “procedure”, or “step”. Further, a watching management method is a method that is carried out by execution of the watching management program by the watching information server 531.

The watching management program may be stored in a recording medium or a storage medium that is computer-readable and may be further provided. Further, the watching management program may be provided as a program product.

Further, the processor may be substituted with an electronic circuit. The processor and the electronic circuit each may be referred to as processing circuitry. That is, functions of devices of the satellite watching system 500 are implemented by the processing circuitry.

Though functions of the watching information server 531 are implemented by software in FIG. 2, the functions may be implemented by hardware. Specifically, the watching information server 531 may include an electronic circuit in place of the processor 910.

The electronic circuit is a dedicated electronic circuit to implement the functions of the watching information server 531. Specifically, the electronic circuit is a single circuit, a composite circuit, a programmed processor, a parallelly programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functions of the watching information server 531 may be implemented by one electronic circuit or may be distributed among a plurality of electronic circuits so as to be implemented.

In another modification, some functions of the watching information server 531 may be implemented by an electronic circuit and the remaining functions may be implemented by software. Further, some or all of the functions of the watching information server 531 may be implemented by firmware.

The processor and the electronic circuit each may be referred to as processing circuitry. That is, the functions of the watching information server 531 are implemented by the processing circuitry.

Incidentally, hardware configurations of other computers such as the ground installations 54 corresponding to the respective critical infrastructures are similar to those of the watching information server 531.

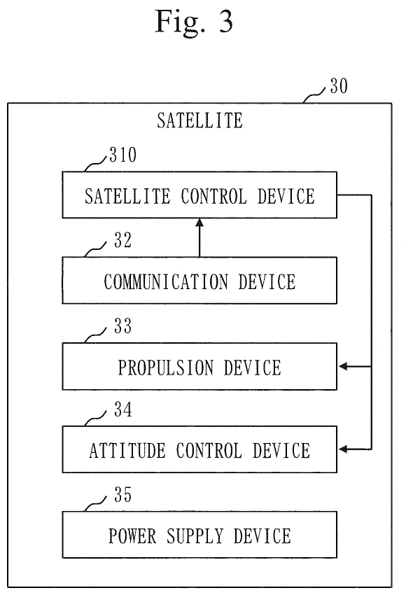

FIG. 3 is a diagram illustrating a configuration example of a satellite 30 according to the present embodiment.

The fundamental configuration example of the satellites 30 such as the infrastructure satellites 511 or the watching satellites 521 will be described.

The satellite 30 includes a satellite control device 310, a communication device 32, a propulsion device 33, an attitude control device 34, and a power supply device 35. The satellite 30 includes other components to implement various functions, whereas the satellite control device 310, the communication device 32, the propulsion device 33, the attitude control device 34, and the power supply device 35 will be described in FIG. 3. The satellite 30 is an example of a space object.

The satellite control device 310 is a computer to control the propulsion device 33 and the attitude control device 34 and includes a processing circuit. Specifically, the satellite control device 310 controls the propulsion device 33 and the attitude control device 34 in accordance with various commands transmitted from a ground device.

The satellite communication device 32 is a device to communicate with ground installations or ground devices. Specifically, the communication device 32 transmits various types of data on the satellite to which itself belongs, to the ground device. Additionally, the communication device 32 receives the various commands transmitted from the ground device.

The propulsion device 33 is a device to give a propulsive force to the satellite 30 and changes a speed of the satellite 30. Specifically, the propulsion device 33 is an apogee kick motor, a chemical propulsion device, or an electric propulsion device. The Apogee Kick Motor (AKM) refers to an upper-stage propulsion device that is used to inject an artificial satellite into an orbit and may be referred to as an apogee motor (when a solid rocket motor is used) or an apogee engine (when a liquid engine is used).

The chemical propulsion device is a thruster for which one-component fuel or two-component fuel is used. The electric propulsion device is an ion engine or a Hall thruster. The apogee kick motor is a name of a device that is used for orbit transition and may be a type of chemical propulsion device.

The attitude control device 34 is a device to control attitude elements such as an attitude of the satellite 30, an angular speed of the satellite 30, and a line of sight. The attitude control device 34 changes the attitude elements in desired directions. Alternatively, the attitude control device 34 maintains the attitude elements in desired directions. The attitude control device 34 includes an attitude sensor, an actuator, and a controller. The attitude sensor is such a device as a gyroscope, an earth sensor, a sun sensor, a star tracker, a thruster, and a magnetic sensor. The actuator is such a device as an attitude control thruster, a momentum wheel, a reaction wheel, and a control moment gyro. The controller controls the actuator in accordance with measured data from the attitude sensor or various commands from the ground device.

The power supply device 35 includes equipment such as a solar cell, a battery, and a power controller and supplies power to each equipment mounted in the satellite 30.

The processing circuit included in the satellite control device 310 will be described.

The processing circuit may be dedicated hardware or may be a processor to execute a program stored in a memory.

In the processing circuit, some functions may be implemented by dedicated hardware and the remaining functions may be implemented by software or firmware. That is, the processing circuit may be implemented by hardware, software, firmware, or a combination of those.

Specifically, the dedicated hardware is a single circuit, a composite circuit, a programmed processor, a parallelly programmed processor, an ASIC, an FPGA, or a combination of those.

### Description of Operation

### Example 1 of Communication Scheme in Satellite Watching System 500

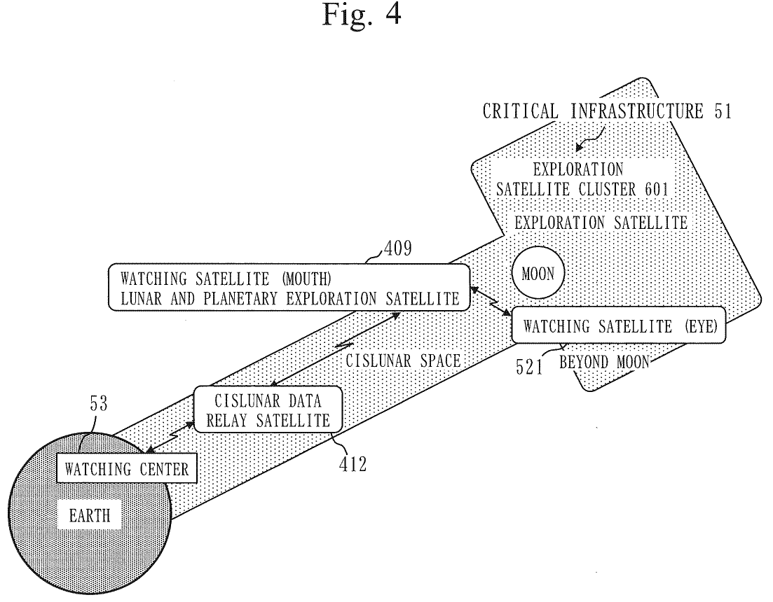

FIG. 4 is a diagram illustrating Example 1 of a communication scheme in the satellite watching system 500 according to the present embodiment.

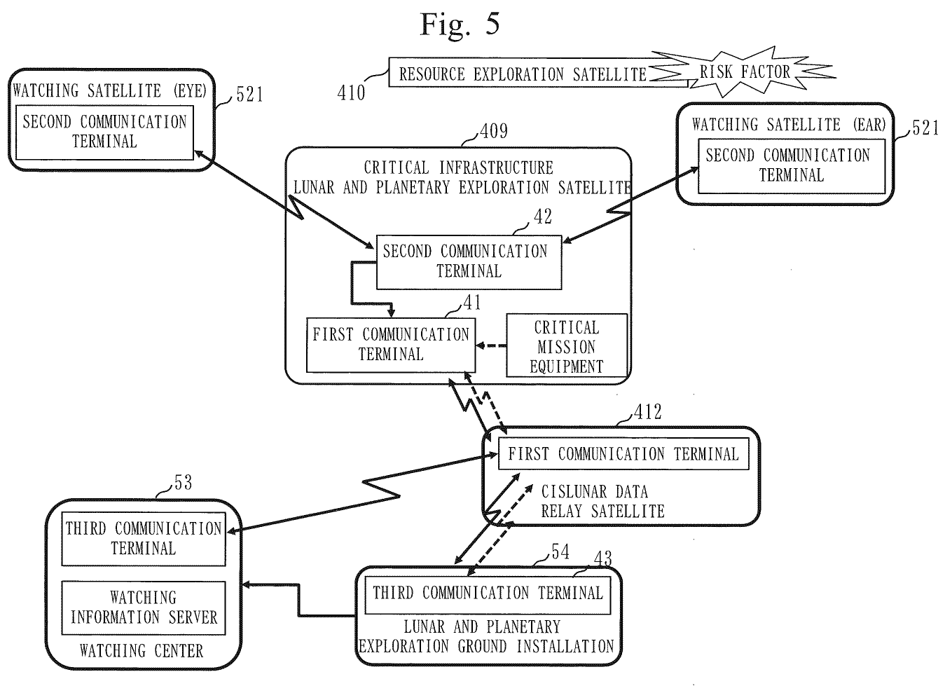

FIG. 5 is a diagram illustrating a configuration example of Example 1 of the communication scheme in the satellite watching system 500 according to the present embodiment.

In Example 1 of the communication scheme, when a watching satellite 521 (watching satellite (eye)) passes through a vicinity of the lunar and planetary exploration satellite 409 (watching satellite (mouth)), the watching satellite 521 (watching satellite (eye)) exchanges the watching information 590 with the lunar and planetary exploration satellite 409. Then, the lunar and planetary exploration satellite 409 (watching satellite (mouth)) exchanges the watching information 590 with the watching center 53 via the cislunar data relay satellite 412.

The lunar and planetary exploration satellite 409 is a satellite in which the environment of communication with the cislunar data relay satellite 412 has been consolidated, as the critical infrastructure 51.

FIG. 5 illustrates a situation in which a watching satellite (ear) monitors the resource exploration satellite 410 that is the infrastructure satellite 511, treats risk factors as the watching information 590, and exchanges the information with the watching center 53.

The watching center 53 exchanges the watching information 590 with the watching satellite (ear) via the lunar and planetary exploration satellite 409 and the cislunar data relay satellite 412. Alternatively, the watching center 53 may exchange the watching information 590 with the watching satellite (ear) via the lunar and planetary exploration satellite 409, the cislunar data relay satellite 412, and the ground installation 54 corresponding to the lunar and planetary exploration satellite 409.

Further, in FIG. 5, mission information is exchanged between critical mission equipment of the lunar and planetary exploration satellite 409 and the ground installation 54 corresponding to the lunar and planetary exploration satellite 409 via the cislunar data relay satellite 412. The critical mission equipment is equipment to carry out missions of the lunar and planetary exploration satellite 409.

The watching satellite 521 includes a second communication terminal 42.

The infrastructure satellite 511 such as the lunar and planetary exploration satellite 409 includes a first communication terminal 41 and the second communication terminal 42.

The cislunar data relay satellite 412 includes the first communication terminal 41.

The watching center 53 and the ground installation 54 each include a third communication terminal 43.

The first communication terminal 41 is a communication terminal for communication between a vicinity of the moon and a vicinity of GEO (stationary orbit) or between the vicinity of GEO and the ground. The first communication terminal 41 carries out “moon-GEO” communication between the infrastructure satellite 511 and the cislunar data relay satellite 412. Further, the first communication terminal 41 carries out “ground-GEO” communication between the cislunar data relay satellite 412 and each of the watching center 53 and the ground installation 54. That is, the first communication terminal 41 is a communication terminal to carry out “moon-GEO” communication and to carry out “ground-GEO” communication.

The second communication terminal 42 is a communication terminal for communication between the watching satellite 521 and the infrastructure satellite 511 or between the infrastructure satellites 511. The second communication terminal 42 carries out “moon vicinity-moon vicinity” communication.

The third communication terminal 43 is a communication terminal that is included in each of the watching center 53 and the ground installations 54 and that is to carry out “ground-GEO” communication with the first communication terminal 41 of the cislunar data relay satellite 412.

On condition that the lunar and planetary exploration satellite 409 flying in the cislunar space and the watching center 53 on the ground communicate with each other, there may be a time zone when the watching center 53 cannot communicate with the lunar and planetary exploration satellite 409, depending on rotation of the earth and a relative position of the moon. By contrast, inclusion of the cislunar data relay satellite 412 produces an effect of improvement in availability of communication with the lunar and planetary exploration satellite 409.

Further, there is a problem in that presence of cloud may make it impossible to carry out optical communication with the ground through atmosphere. Therefore, optical communication suitable for long-distance communication is employed for the long-distance communication between the cislunar space and the stationary orbit, while radio wave communication possible in rainy weather and cloudy weather as well is employed for communication between the stationary orbit and the ground. Thus, the satellite watching system 500 produces an effect in that the communication between the cislunar space and the ground is enabled without dependence on weather.

Incidentally, following schemes are known as schemes to implement the intersatellite optical communication.
O3K scheme employed in LEO (Low Earth Orbit) constellation and suitable for short range low-rate communication: Optical On/Off Keying
HDR scheme employed in GEO-LEO optical communication (middle range): Optical High Data Rate
HPE scheme suitable for further capacity enlargement or long-range communication: High Photon Efficiency

The long-range communication with HPE scheme is employed for between the cislunar space and the cislunar data relay satellite. Further, HDR scheme or O3K scheme is employed for between the watching satellite and the lunar and planetary exploration satellite, depending on a communication distance. Thus, an effect is produced in that a total cost for the satellite watching system 500 can be lowered.

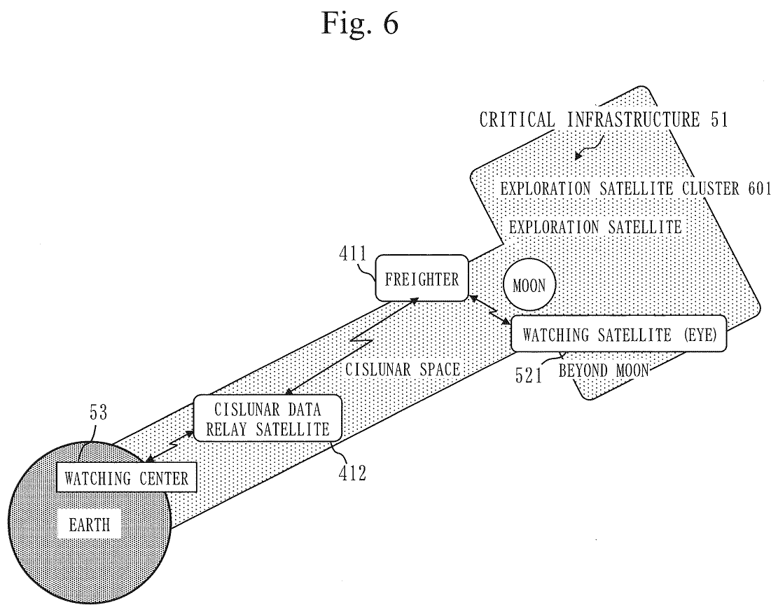

FIG. 6 is a diagram illustrating another example of Example 1 of the communication scheme in the satellite watching system 500 according to the present embodiment.

As illustrated in FIG. 6, the critical infrastructures 51 may include the freighter 411 which has the consolidated environment of communication with the cislunar data relay satellite 412 and transports commodities to the cislunar space.

The freighter 411 transports the watching satellite 521 to the cislunar space and thereafter releases the watching satellite 521. Then, the watching satellite 521 exchanges the watching information 590 with the freighter 411. The freighter 411 exchanges the watching information 590 with the watching center 53 via the cislunar data relay satellite 412.

A method by which the freighter 411 (watching satellite (mouth)) exchanges the watching information 590 with the watching center 53 via the cislunar data relay satellite 412 is similar to the method described in FIGS. 4 and 5. That is, the freighter 411 (watching satellite (mouth)) exchanges the watching information 590 with the watching center 53 via the cislunar data relay satellite 412 as with the method by which the lunar and planetary exploration satellite 409 (watching satellite (mouth)) exchanges the watching information 590 with the watching center 53 via the cislunar data relay satellite 412 in FIGS. 4 and 5.

The cislunar freighter (freighter 411) may be a rocket. Further, the cislunar freighter may be a freighter to be separated from a rocket after being launched with the rocket and to transport commodities to a destination, like an advanced transfer vehicle for space station (HTV-X).

Freighters to transport commodities to the cislunar space each necessarily include a communication device capable of long-range communication. Accordingly, an effect is produced in that a watching satellite can be implemented with small sizes and a light weight and at a low cost by transport of the watching satellite to the cislunar space by the freighter and utilization of long-range communication lines for the freighter posterior to the release.

Further, it is rational to release the watching satellite around the destination, because the critical infrastructure as a subject to be watched necessarily exists at the destination of the cislunar freighter.

Further, transport of the infrastructure satellite by the cislunar freighter produces a similar effect.

The freighter 411 transports the infrastructure satellite to the cislunar space and thereafter releases the infrastructure satellite. The infrastructure satellite exchanges satellite information with the freighter 411 and the freighter 411 exchanges the satellite information with the ground installations 54 corresponding to respective infrastructures via the cislunar data relay satellite 412.

### Example 2 of Communication Scheme in Satellite Watching System 500

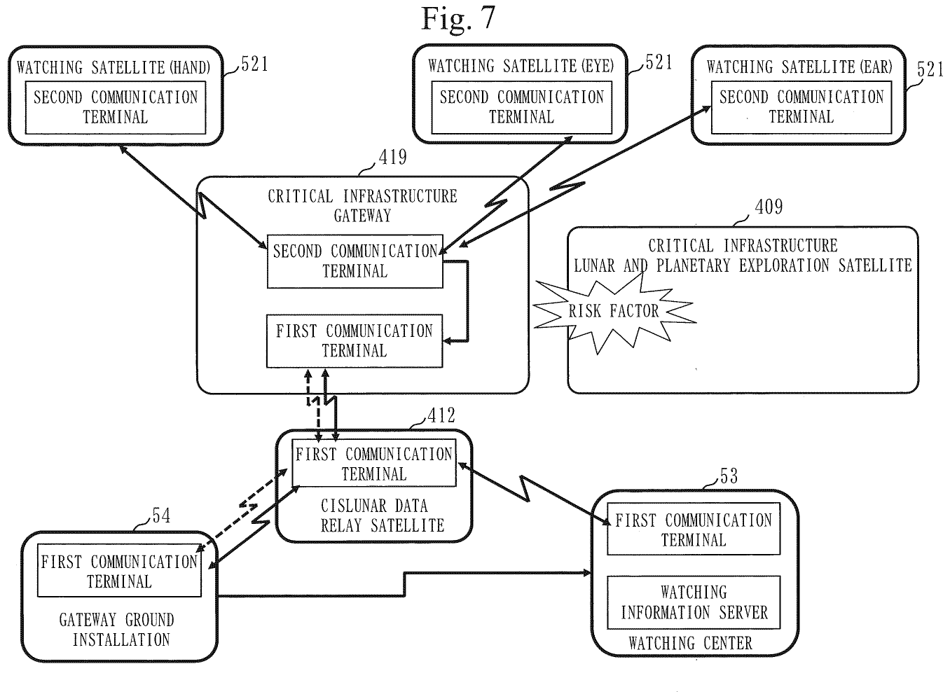

FIG. 7 is a diagram illustrating a configuration example of Example 2 of a communication scheme in the satellite watching system 500 according to the present embodiment.

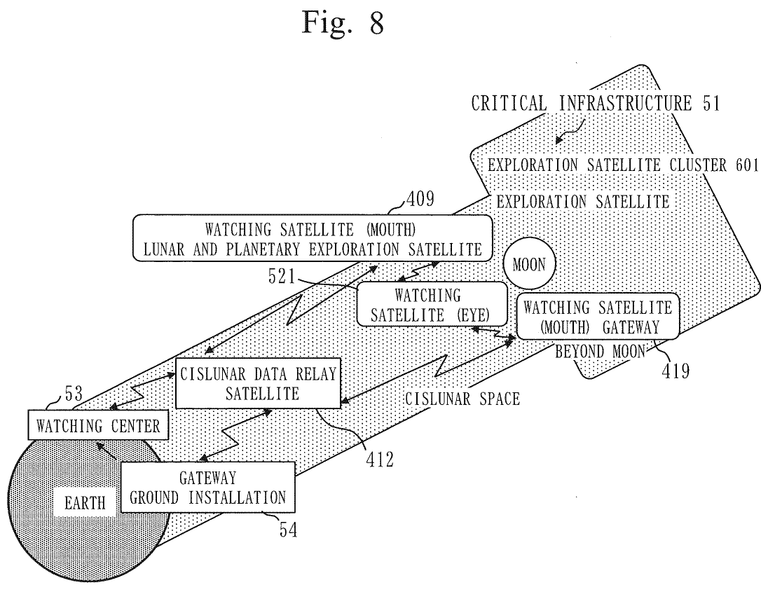

FIG. 8 is a diagram illustrating Example 2 of the communication scheme in the satellite watching system 500 according to the present embodiment.

On condition that the only one lunar and planetary exploration satellite 409 is operated and that there is only one communication line, there is a risk that the communication may black out due to a failure or an emergency in the lunar and planetary exploration satellite 409 itself. On this condition, information (watching information) for watching the lunar and planetary exploration satellite 409 is transmitted through borrowing of a communication line through which the gateway 419 and the ground communicate with each other via the cislunar data relay satellite 412.

FIG. 7 illustrates a situation in which the watching satellites 521 monitor the lunar and planetary exploration satellite 409 that is the infrastructure satellite 511, treat a risk factor as the watching information 590, and exchange the information with the watching center 53. The infrastructure satellite cluster includes the cislunar data relay satellite 412 to relay communication between a space object flying in the near-moon orbit and the ground.

The watching center 53 exchanges the watching information 590 with the watching satellite 521 via the gateway 419 and the cislunar data relay satellite 412. Alternatively, the watching center 53 may exchange the watching information 590 with the watching satellite 521 via the gateway 419, the cislunar data relay satellite 412, and the ground installation 54 corresponding to the gateway 419.

The gateway 419 is a satellite in a vicinity of the moon. The gateway 419 is a satellite of which construction based on international cooperation is planned.

The infrastructure satellites 511 such as the gateway 419 include a first communication terminal and a second communication terminal. Incidentally, information on gateway services is exchanged between the gateway 419 and the ground installation 54 corresponding to the gateway 419 via the cislunar data relay satellite 412.

FIG. 7 illustrates an example in which the ground installation 54 and the watching center 53 each include the first communication terminal.

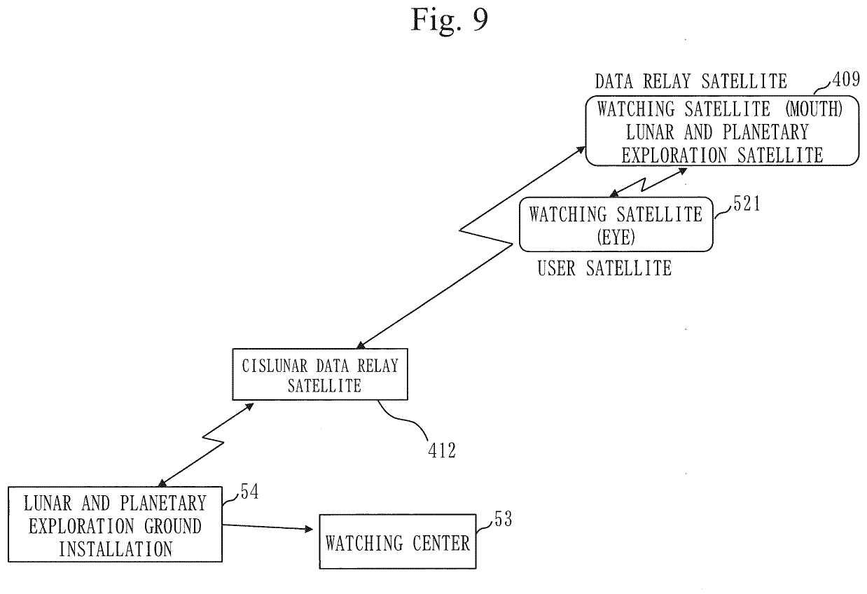

FIG. 9 is a diagram illustrating a configuration example in which communication is carried out with a lunar and planetary exploration satellite regarded as a data relay satellite and with a watching satellite regarded as a user satellite, according to the present embodiment.

As described in FIGS. 7 and 8, it is necessary in the cislunar space to construct the satellite watching system 500 in consideration of communication compatibility with the gateway 419.

Assuming that the gateway 419 is not taken into consideration, a communication instrument configuration is formed in which the watching satellite 521 is regarded as a user satellite for the data relay satellite and in which the lunar and planetary exploration satellite 409 is regarded as the data relay satellite, as illustrated in FIG. 9.

In FIG. 9, the lunar and planetary exploration satellite 409 regarded as the data relay satellite communicates with the ground installation 54 for lunar and planetary exploration via the cislunar data relay satellite 412.

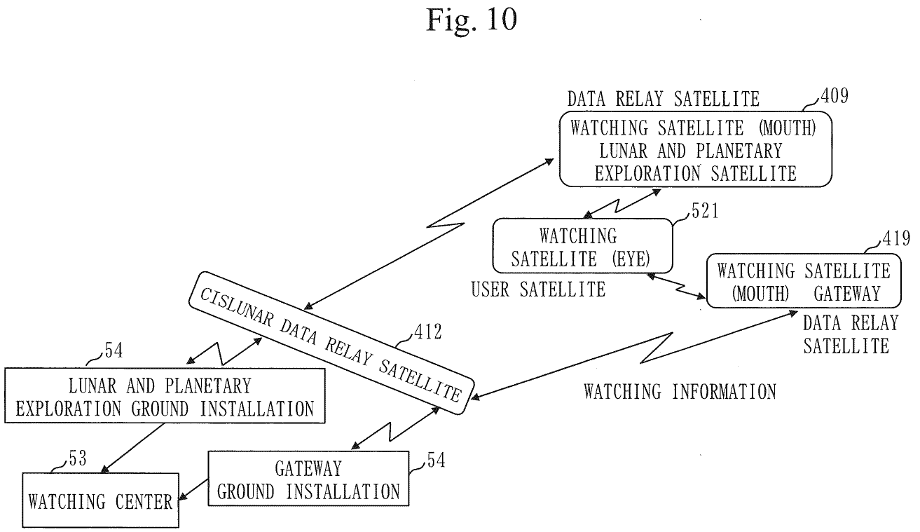

FIG. 10 is a diagram illustrating a configuration example in which communication is carried out with the lunar and planetary exploration satellite and the gateway regarded as the data relay satellites and with the watching satellite (eye) regarded as the user satellite, according to the present embodiment.

There may be a case where a failure or an emergency may occur in the lunar and planetary exploration satellite 409 and where the gateway 419 has to be used as a data relay satellite for backup. In such a case, it is reasonable to employ a standard communication terminal capable of communicating with the gateway in the watching satellite (eye). Further, the lunar and planetary exploration satellite 409 to relay data for the watching satellite (eye) as the user satellite needs to include a communication terminal similar to that of the gateway 419.

The gateway 419 regarded as the data relay satellite communicates with the watching center 53 via the cislunar data relay satellite 412. The gateway 419 may communicate with the watching center 53 via the cislunar data relay satellite 412 and the ground installation 54 for the gateway.

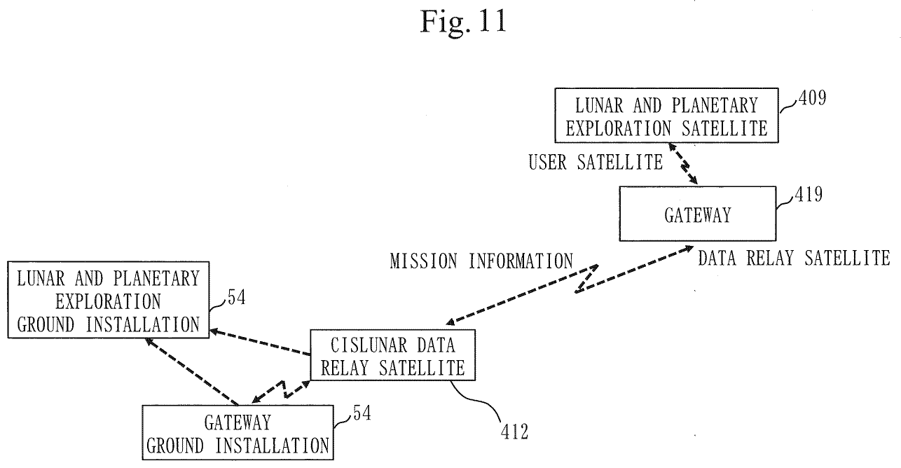

FIG. 11 is a diagram illustrating a configuration example in which communication is carried out with the gateway regarded as the data relay satellite and with the lunar and planetary exploration satellite regarded as the user satellite, according to the present embodiment.

It is assumed that the lunar and planetary exploration satellite 409 originally includes a communication terminal for establishing an environment of communication with the gateway 419. In this case, settings of the communication terminal in which the lunar and planetary exploration satellite 409 is regarded as the user satellite and in which the gateway 419 is regarded as the data relay satellite are assumed.

The gateway 419 regarded as the data relay satellite communicates with the ground installation 54 for lunar and planetary exploration via the cislunar data relay satellite 412. Alternatively, the gateway 419 regarded as the data relay satellite may communicate with the ground installation 54 for lunar and planetary exploration via the cislunar data relay satellite 412 and the ground installation 54 for the gateway.

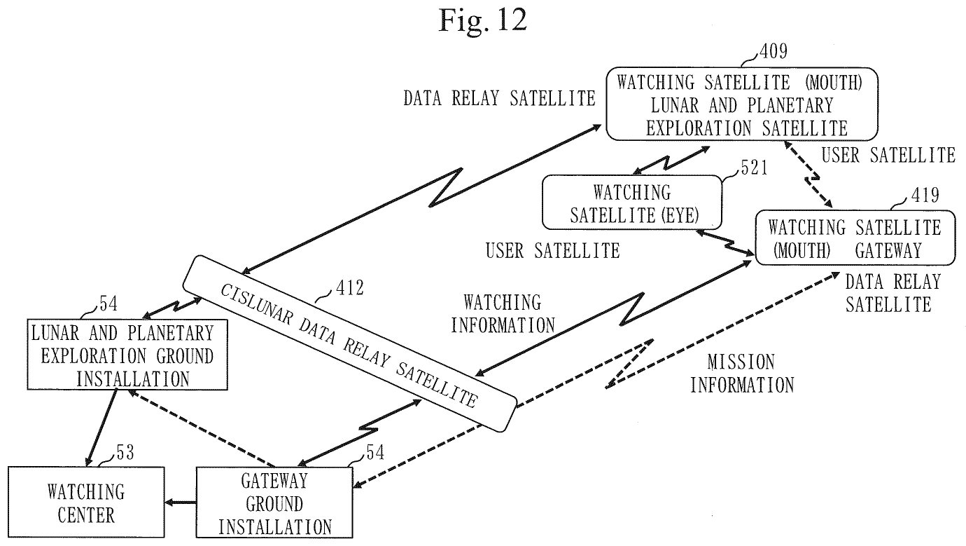

FIG. 12 is a diagram illustrating a configuration example in which communication is carried out with the gateway regarded as the data relay satellite and with the lunar and planetary exploration satellite regarded as the user satellite, meanwhile, with the lunar and planetary exploration satellite regarded as the data relay satellite and with the watching satellite regarded as the user satellite, according to the present embodiment.

In FIG. 12, mission information for the lunar and planetary exploration satellite 409 is exchanged, for instance, with the gateway 419 regarded as the data relay satellite and with the lunar and planetary exploration satellite 409 regarded as the user satellite. Further, watching information is exchanged with the lunar and planetary exploration satellite 409 or the gateway 419 regarded as the data relay satellite and with the watching satellite 521 regarded as the user satellite.

Providing that communication between the watching satellite including the standard communication terminal and the lunar and planetary exploration satellite is enabled by a communication terminal intended for communication between the gateway 419 and the lunar and planetary exploration satellite 409, thorough solution is attained by employment of the standard communication terminal.

On condition that specifications of the communication terminals differ between the user satellite and the data relay satellite, however, both the communication terminals need to be included in a side of the lunar and planetary exploration satellite.

Specifics are as follows.

All of following communications are enabled on condition that a bidirectional HPE optical communication scheme for long-range communication is employed for between the cislunar data relay satellite 412 and the gateway 419, for instance, and that the lunar and planetary exploration satellite 409 includes a terminal of the same HPE optical communication scheme as the standard terminal.
Between the cislunar data relay satellite 412 and the gateway 419
Between the cislunar data relay satellite 412 and the lunar and planetary exploration satellite 409
Between the lunar and planetary exploration satellite 409 and the gateway 419

Further, providing that the watching satellite 521 also includes the terminal of the same HPE optical communication scheme, the watching satellite is capable of communicating with all of the cislunar data relay satellite 412, the gateway 419, and the lunar and planetary exploration satellite 409, as well.

The HPE scheme, however, is expensive and thus has a demerit in terms of cost.

Accordingly, providing that the watching satellite 521 employs the HDR scheme suitable for middle range or the O3K scheme suitable for short range, costs of the watching satellite 521 can be lowered.

In this case, the lunar and planetary exploration satellite 409 or the gateway 419 to communicate with the watching satellite 521 needs to include optical communication terminals of a plurality of schemes, that is, the HPE scheme and the HDR scheme or the O3K scheme.

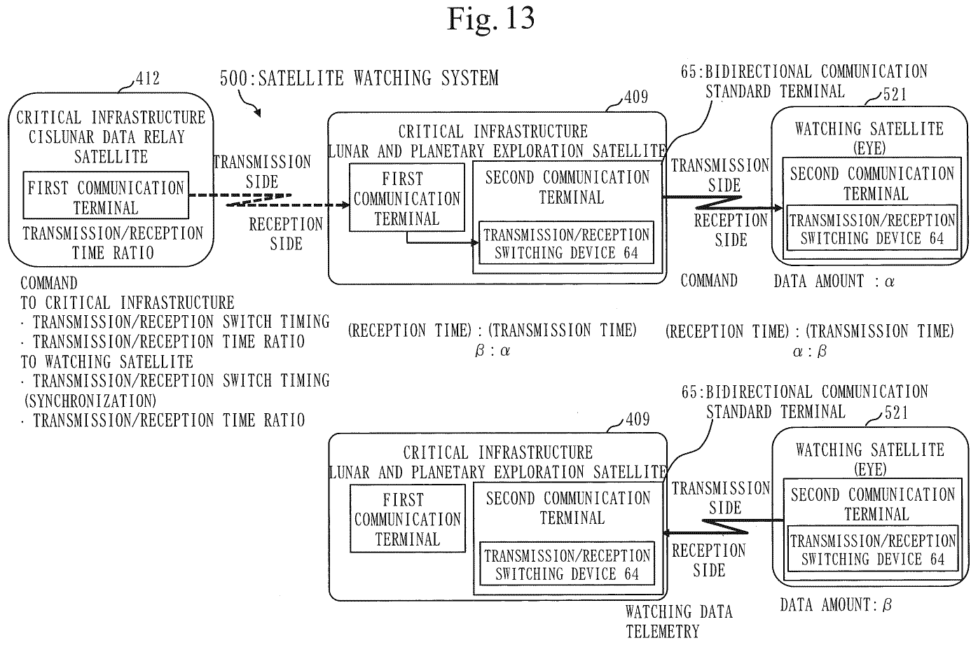

FIG. 13 is a diagram illustrating a communication scheme in the satellite watching system 500 according to the present embodiment.

FIG. 13 illustrates a mechanism of command transmission on transmission/reception switching and transmission/reception time ratio for a bidirectional communication standard terminal 65 in the communication schemes of the satellite watching system 500.

Each satellite in the infrastructure satellite cluster 501 and the watching satellite cluster 52 includes the bidirectional communication standard terminal 65 with a transmission/reception switching device 64. The transmission/reception switching device 64 is a device to implement reception and transmission by switching between a receiving function and a transmitting function.

In FIG. 13, the second communication terminal is the bidirectional communication standard terminal 65 with the transmission/reception switching device 64.

The watching center 53 operates the transmission/reception switching device 64, based on a data amount α and a data amount β, so that a ratio between reception time and transmission time of the watching satellite becomes α versus β. The data amount α is a data amount of commands that are transmitted from the watching center 53 to the watching satellite 521. The data amount β is a data amount of watching data and telemetry data that are received by the watching center 53 from the watching satellite 521.

The watching center 53 carries out exchange of information between the watching satellite cluster 52 and the watching center 53 via the lunar and planetary exploration satellite 409.

The watching satellite 521 includes the bidirectional communication standard terminal 65 with the transmission/reception switching device 64 and controls the transmission/reception time ratio by a command.

On condition that the watching satellite 521 is an optical monitoring satellite which assumes the role of eye, a data amount of the watching information becomes enormous. Therefore, the ratio between the reception time and the transmission time is regulated to be α:β, in accordance with the data amount α of the commands that are received by the watching satellite and the total data amount β of the watching data and the telemetry that are transmitted. Thus, performance of the standard communication terminal can be exerted one-hundred-percent and high-speed high-capacity communication is enabled.

As a result, an effect is produced in that resources of the data relay satellite to communicate with a large number of satellites can be efficiently utilized.

Optical communication terminals to carry out communication between a geostationary orbit data relay satellite and a low-earth-orbit satellite have been implemented. For the optical communication terminals, at this time, a side of the low-earth-orbit satellite to transmit information such as observed data is treated as a side of the user satellite and the data relay satellite is treated as a host side. Even for optical communication terminals to communicate with each other, which may differ in opening diameter between the host side and the user side, standardization of the communication terminals has not been carried out.

Meanwhile, for the communication terminals according to the present embodiment, roles of the host side and the user side may change depending on an information transmission path. Therefore, it is rational to use standard terminals having common specifications without distinction between the host side and the user side. Under this condition, it is necessary to carry out time-division switching of roles of transmission side and reception side with use of the terminals having the same specifications. Accordingly, the communication terminals include the transmission/reception switching devices. Further, on condition that the data amounts differ between transmission and reception, it is rational to optimize the ratio of transmission/reception time in accordance with the data amounts. It is rational to make command transmission of the ratio of transmission/reception time from the watching center having comprehended the data amount of the commands and the data amount of the watching information and the telemetry.

Alternatively, optimizing control may be exerted with autonomous monitoring of operation duty of the transmission/reception on the orbit.

Means of changing polarization for transmission and reception for avoidance of interference of transmission/reception signals or prevention of malfunction is also effective.

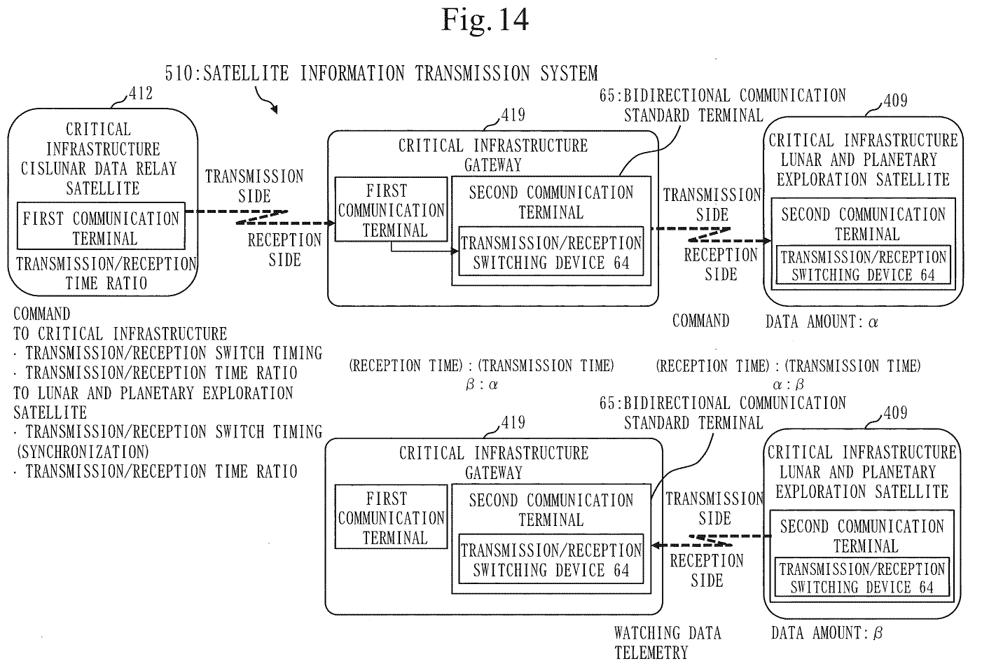

FIG. 14 is a diagram illustrating a communication scheme in a satellite information transmission system 510 according to the present embodiment.

FIG. 14 illustrates a mechanism of command transmission on the transmission/reception switching and the ratio of transmission/reception time for the bidirectional communication standard terminal 65 in a communication scheme of the satellite information transmission system 510.

The infrastructure satellite 511 includes the bidirectional communication standard terminal 65 with the transmission/reception switching device 64. The bidirectional communication standard terminal 65 with the transmission/reception switching device 64 is a communication terminal with the transmission/reception switching device 64 that has communication compatibility with the gateway 419 in a vicinity of the moon and that is to implement reception and transmission by switching between the receiving function and the transmitting function.

The cislunar data relay satellite 412 operates the transmission/reception switching device 64 so that a ratio between reception time and transmission time of a first infrastructure satellite becomes α versus β. The cislunar data relay satellite 412 operates the transmission/reception switching device 64, based on data amount α of commands that are transmitted to the first infrastructure satellite and data amount β of mission data and telemetry data that are received from the first infrastructure satellite.

In FIG. 14, the lunar and planetary exploration satellite 409 is illustrated as an example of the first infrastructure satellite.

### Other Configurations

### Modification 1

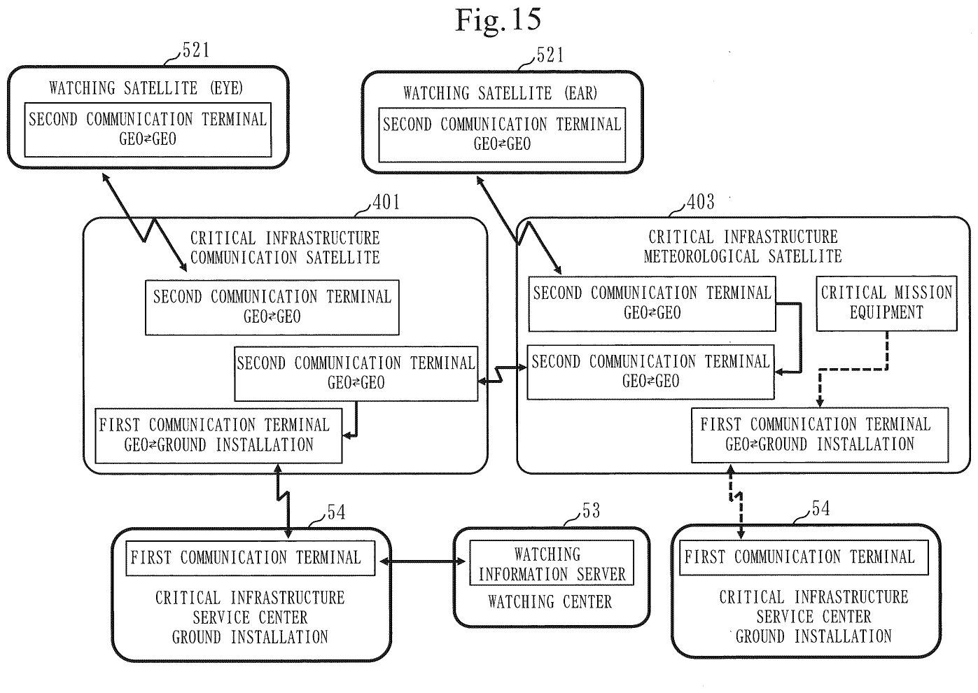

FIG. 15 is a diagram illustrating a configuration example of the satellite watching system 500 according to Modification 1 of the present embodiment.

FIG. 15 illustrates a case where the infrastructure satellites 511 are a communication satellite 401 and a meteorological satellite 403.

To the case of Modification 1 as well, a mechanism of controlling communication by command transmission on the transmission/reception switching and the ratio of transmission/reception time for a bidirectional communication standard terminal from a ground installation can be applied.

### Embodiment 2

As for the present embodiment, additions to or differences from Embodiment 1 will be described chiefly. Incidentally, configurations that are similar to those of Embodiment 1 are provided with identical reference characters and description thereof may be omitted.

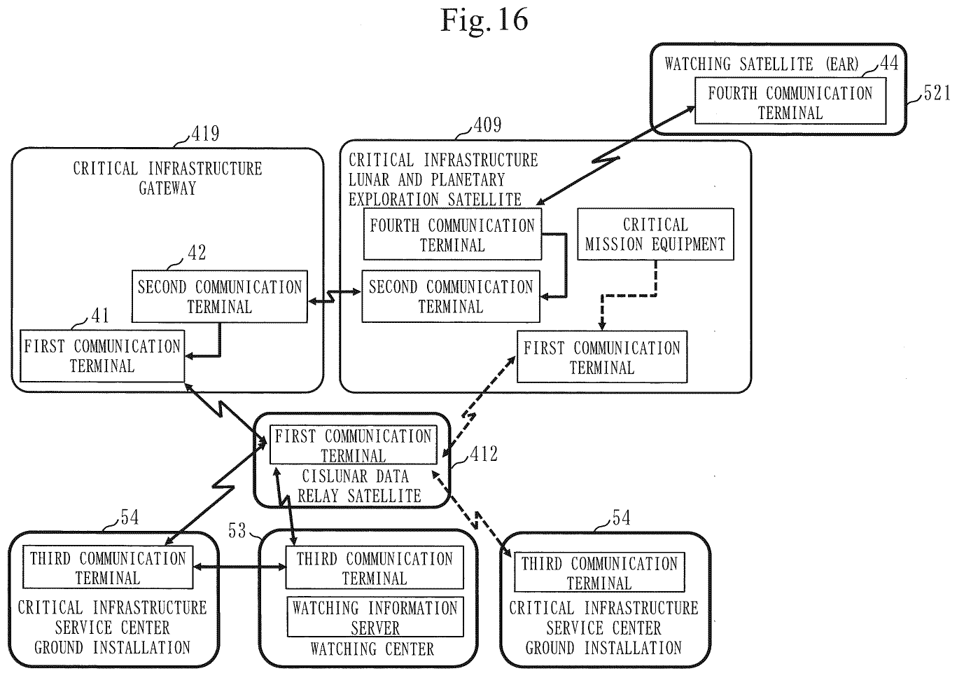

FIG. 16 is a diagram illustrating an example of a communication scheme in the satellite watching system 500 according to the present embodiment.

The lunar and planetary exploration satellite 409 that is the infrastructure satellite includes the second communication terminal 42 and a communication terminal (fourth communication terminal 44) to communicate with the watching satellite 521.

The second communication terminal 42, having the communication compatibility with the gateway 419, is the bidirectional communication standard terminal 65 with the transmission/reception switching device 64.

Further, the fourth communication terminal 44 is a communication terminal to carry out communication between the watching satellite and the infrastructure satellite.

Further, the infrastructure satellite cluster 501 includes the cislunar data relay satellite 412 to relay communication between a space object flying in the near-moon orbit and the ground.

The cislunar data relay satellite 412 includes the first communication terminal 41.

The first communication terminal 41 is a communication terminal for communication between the vicinity of the moon and the vicinity of GEO. Further, the first communication terminal 41 has a function of carrying out communication between GEO and the ground, as well.

Further, the watching center 53 and the ground installation 54 each include the third communication terminal 43 for the communication between GEO and the ground.

The watching satellite 521 includes the fourth communication terminal 44 to communicate with the infrastructure satellite.

In the satellite watching system 500 according to the present embodiment, exchange of information between the watching satellite 521 and the watching center 53 is carried out via the infrastructure satellite and the cislunar data relay satellite 412. Alternatively, in the satellite watching system 500, the exchange of information between the watching satellite 521 and the watching center 53 may be carried out via the infrastructure satellite, the cislunar data relay satellite 412, and the ground installation 54 that operates the infrastructure satellite.

The satellite watching system disclosed in Embodiment 1 can be implemented on condition that the communication terminal having the communication compatibility with the gateway has specifications that enable use thereof without the distinction between the user side and the host side in intersatellite data relay. Meanwhile, on condition that the specifications differ between the user side and the host side, the satellite watching system is constructed with the infrastructure satellite side including both of the host-side communication terminal and the user-side communication terminal in the intersatellite data relay in accordance with the method disclosed in the present embodiment.

In this case, the fourth communication terminal for between the watching satellite and the infrastructure satellite is mounted. Therefore, there is a merit in that optimum mounted equipment can be employed in consideration of communication performance, satellite mountability, costs, and the like.

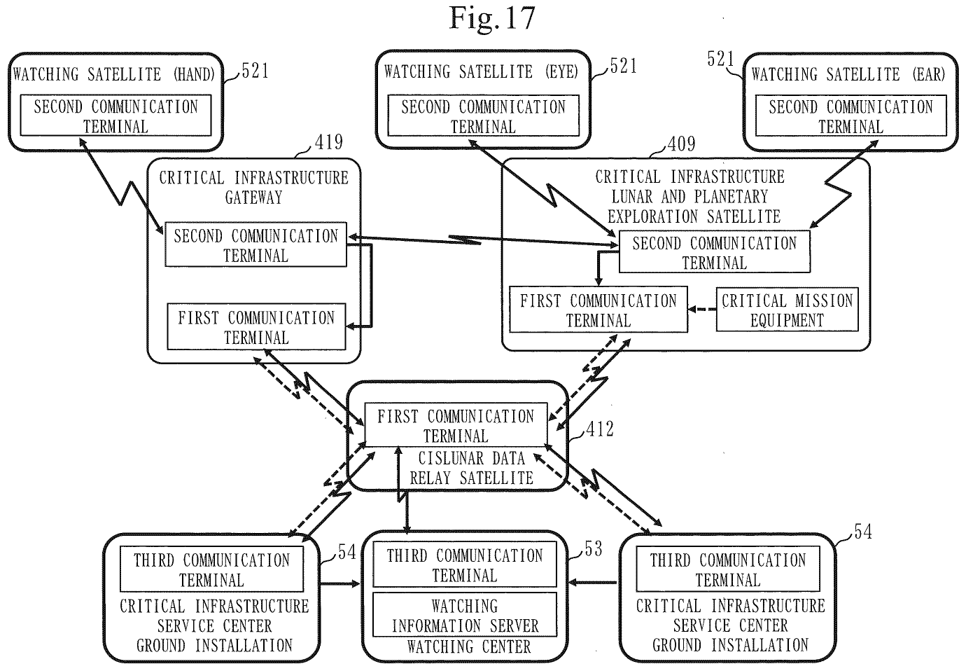

FIG. 17 is a diagram illustrating another example of a communication scheme in the satellite watching system 500 according to the present embodiment.

The watching center 53 includes the watching information server 531 and exchanges the watching information 590 via the cislunar data relay satellite 412. Alternatively, the watching center 53 may exchange the watching information 590 via the cislunar data relay satellite 412 and the ground installations 54 corresponding to the infrastructure satellites 511.

### Embodiment 3

As for the present embodiment, additions to or differences from Embodiments 1 and 2 will be described chiefly. Incidentally, configurations that are similar to those of Embodiments 1 and 2 are provided with identical reference characters and description thereof may be omitted.

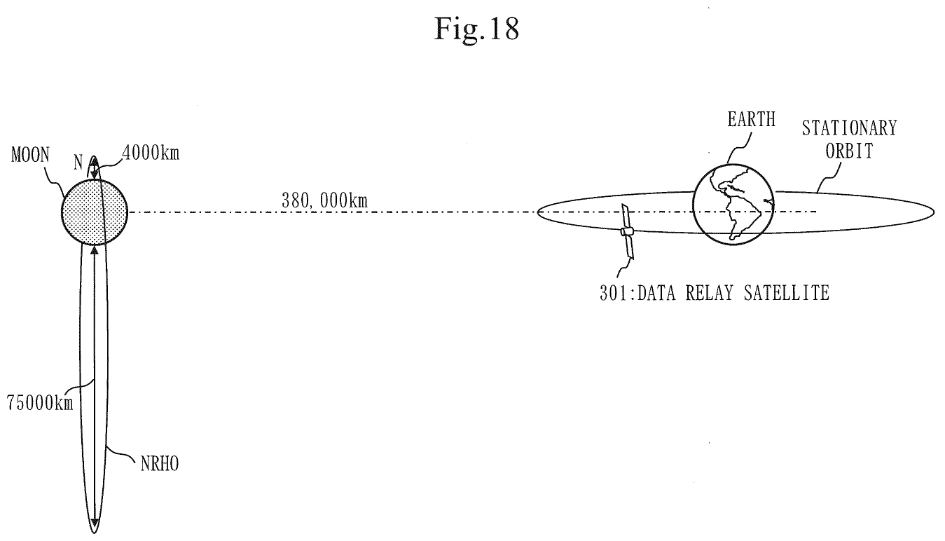

FIG. 18 is a diagram illustrating a background in which a data relay satellite 301 according to the present embodiment is used.

The cislunar data relay satellite 412 described above is an example of the data relay satellite 301.

There is a plan of LOP-G as a base for lunar and planetary exploration in future. LOP-G is an abbreviation for Lunar Orbital Platform-Gateway.

The LOP-G is planned to be operated in an extremely elongated elliptical orbit called NRHO at a Lagrange point that is an equilibrium point of gravitational potentials of the earth and the moon. NRHO is an abbreviation for Near Rectilinear Halo Orbit.

The NRHO is an extremely elongated elliptical orbit that extends around the moon in north-south directions and that ranges from an altitude of 4000 km to an altitude of 75000 km.

A scheme of establishing a communication line from the earth and minimizing communication blackout site for NRHO having a perigee above Arctic of the moon and having an apogee above Antarctic is examined. Utilization of a data relay satellite flying in a stationary orbit above the earth is one of candidate plans.

Further, utilization as communication means of optical communication with which implementation of high-capacity communication is expected is examined.

The present embodiment provides means to minimize a period of communication blackout by optical communication between the gateway flying in NRHO and the data relay satellite in a stationary orbit above the earth.

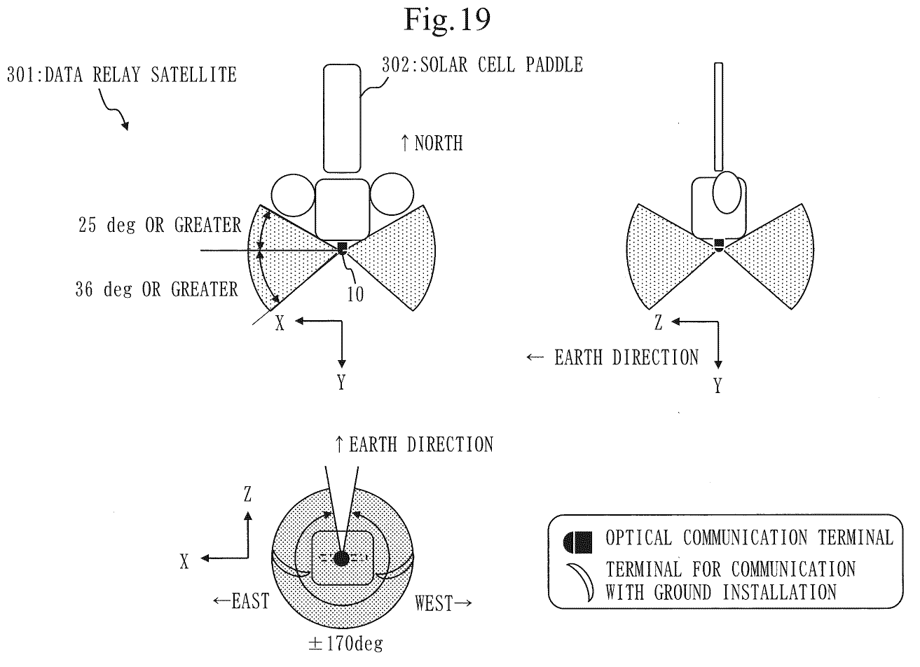

FIG. 19 is a diagram illustrating a configuration example of the data relay satellite 301 according to the present embodiment.

The cislunar data relay satellite 412 described above is an example of the data relay satellite 301.

The data relay satellite 301 relays communication between a space object flying in the near-moon orbit and the ground installation. The data relay satellite 301 flies in a stationary orbit.

In the data relay satellite 301, having X axis of a satellite coordinate system in east-face traveling direction, Y axis in south direction, and Z axis in earth direction, a solar cell paddle 302 has a north face (−Y) one wing configuration.

In the data relay satellite 301, an optical communication terminal 10 is mounted on south face (+Y).

Further, the data relay satellite 301 ensures a communication visual field including Azimuth of ±170 deg with respect to a counter-earth direction (−Z axis) around a north-south axis (Y axis) and a communication visual field with Elevation of −25 deg or greater (north side) and Elevation of 36 deg or greater (south side) with respect to XZ plane.

The data relay satellite is capable of communicating with the gateway without concealment behind the moon because a normal vector of an orbit plane of NRHO extends in the earth direction. In a stationary orbit of the earth, by contrast, communication with the gateway blacks out in a season and a time zone when the data relay satellite is concealed behind the earth from the moon. Further, when the data relay satellite goes round while being directed to the earth, the gateway revolves around a north-south axis.

Earth's axis is inclined by about 23.4 degrees with respect to an inertial space and there is a variation of ±23.4 degrees in oriented direction between winter solstice and summer solstice.

There may be a situation in which the concealment by the earth does not occur depending on the season because of a radius of the stationary orbit of about 42000 km that is about seven times a radius of the earth of about 6400 km and because of inclination of the earth's axis.

Therefore, the optical communication terminal that rotates a visual field direction around the north-south axis of the satellite is employed in order to minimize communication blackout during one round of the data relay satellite above equator of the earth. In order that visual field interference on the satellite may be eliminated, the optical communication terminal is mounted on the south face of the satellite where a broad visual field on an apogee side of NRHO can be ensured. Therein, a visual field for the optical communication with the gateway is ensured by change in oriented directions of two axes of Azimuth and Elevation.

For the optical communication terminal that is incapable of continuous pivoting of 360 degrees or more as an actuation range of the optical communication terminal, the earth direction is assigned as a dead zone. Further, ±170 deg with respect to the counter-earth direction is included in Azimuth rotation range with mounting on the south face. An optical communication terminal with ±175 deg actually exists and the period of communication blackout can be proportionally shortened with broadening in the visual field.

Further, Azimuth directivity angle is set in farthest east, while the gateway is concealed behind the earth, and the Azimuth directivity angle pivots to farthest west, while the data relay satellite makes about one round of the earth with formation of a communication link after exit from a shadow area. Thus, operation in which the Azimuth directivity angle is set afresh in farthest east after entry into the shadow area is iterated.

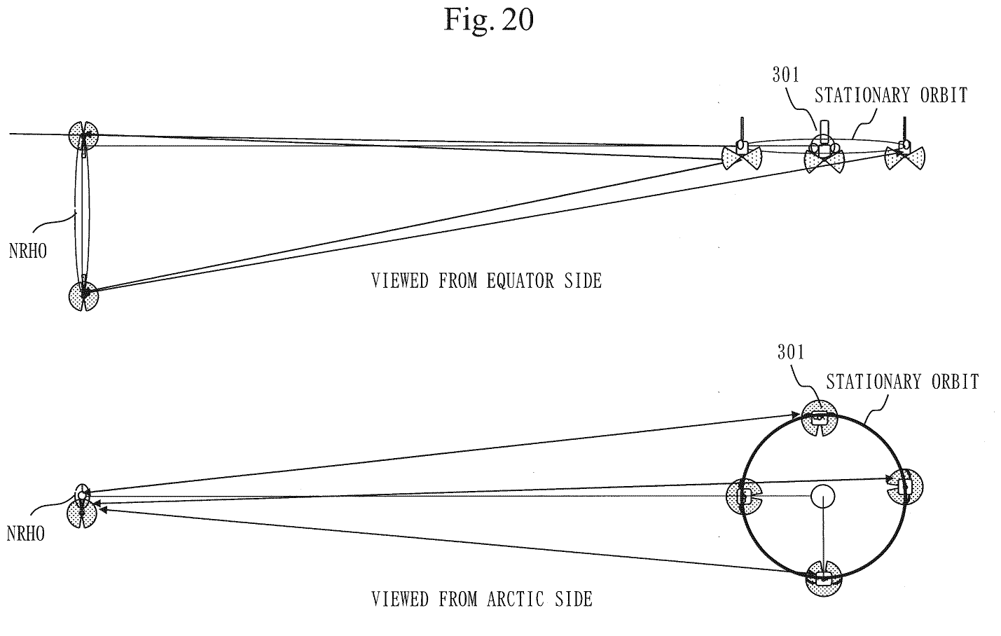

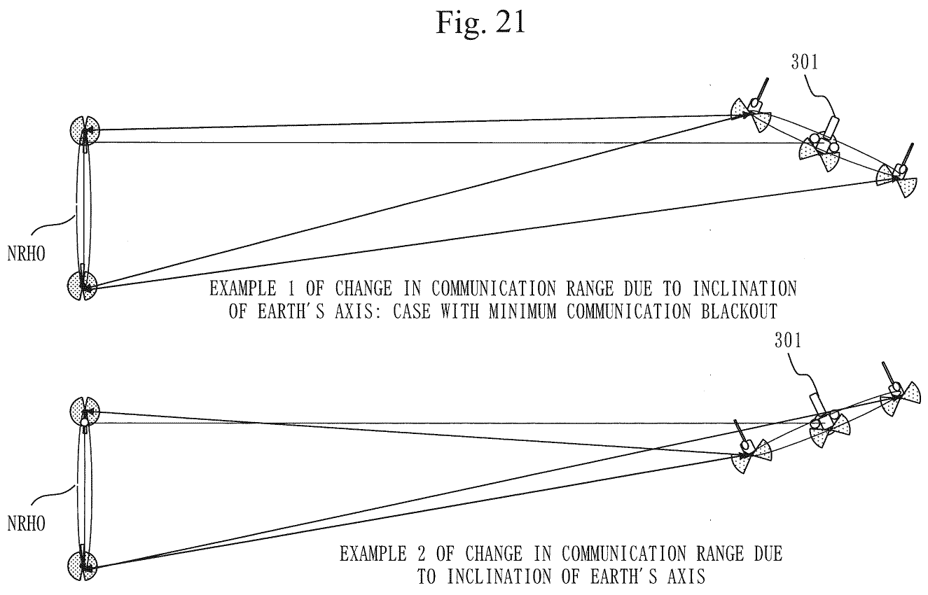

FIG. 20 and FIG. 21 are diagrams illustrating examples of transmission with use of the data relay satellite 301 according to the present embodiment.

An upper portion of FIG. 20 is a diagram of the example of transmission by the data relay satellite 301, viewed from a side of the equator.

A lower portion of FIG. 20 is a diagram of the example of transmission by the data relay satellite 301, viewed from a side of the Arctic.

An upper portion of FIG. 21 illustrates Example 1 of change in communication range due to the inclination of the earth's axis in the example of transmission by the data relay satellite 301.

A lower portion of FIG. 21 illustrates Example 2 of change in communication range due to the inclination of the earth's axis in the example of transmission by the data relay satellite 301.

A distance between the earth and the moon is about 385000 km.

The altitude of the apogee of NRHO is about 75000 km and the altitude of the perigee is about 4000 km.

Accordingly, an angle of the perigee of NRHO above the Arctic, viewed from the data relay satellite 301, is as follows, with X axis of the satellite coordinate system set in the east-face traveling direction, Y axis set in the south direction, and Z axis set in the earth direction.
Elevation with respect to XZ plane of the satellite is 1 deg or smaller in north latitude direction.
An angle of view of the apogee above the Antarctic as Elevation with respect to Z axis (earth direction) of the satellite is 12 deg or smaller in south latitude direction.

Providing that a following oriented direction changing function is included in consideration of a variation in the inclination of the earth's axis of about 23.4 deg, communication can be constantly carried out in a flight path of the gateway ranging from the apogee to the perigee.
Elevation of 25 deg or greater in the north latitude direction
Elevation of 36 deg or greater in the south latitude direction

Manned activities have been planned for the gateway. According to the present embodiment, an effect is produced in that communication with the ground installation can be carried out without communication blackout over a long time span in such an event as an extra-vehicular activity that may concern human life.

Incidentally, it is needless to say that north and south are interchanged in placement of the data relay satellite on condition that the perigee of NRHO is set on the Antarctic side of the moon.

Further, even if the orbit of the gateway is changed during operation, operation in which the north and the south are interchanged by rotation of the data relay satellite by 180 degrees around Z axis can be carried out and can produce an effect similar to the effect described above.

### Other Configurations

### Modification 2

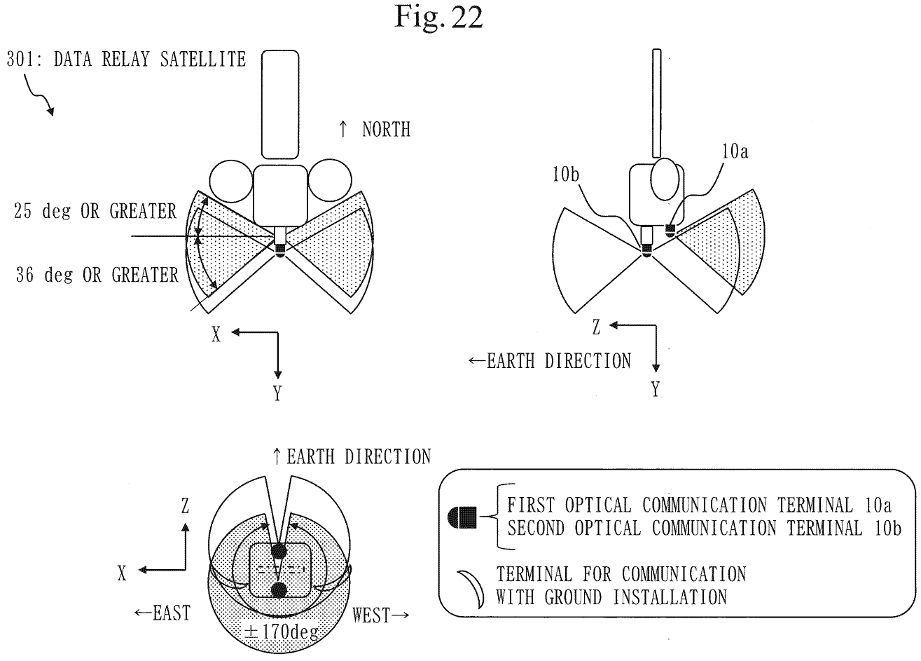

FIG. 22 is a diagram illustrating a configuration example of the data relay satellite 301 according to Modification 2 of the present embodiment.

In the data relay satellite 301, having X axis of a satellite coordinate system in east-face traveling direction, Y axis in south direction, and Z axis in earth direction, the solar cell paddle 302 has a north face (−Y) one wing configuration.

In the data relay satellite 301, the optical communication terminal 10 is mounted on south face (+Y).

In the modification of the present embodiment, the data relay satellite 301 includes two optical communication terminals 10, which are a first optical communication terminal 10a and a second optical communication terminal 10b.

The first optical communication terminal 10a and the second optical communication terminal 10b each ensure a communication visual field including Azimuth of ±170 deg with respect to the counter-earth direction (−Z axis) around the north-south axis (Y axis) and a communication visual field with Elevation of −25 deg or greater (north side) and Elevation of 36 deg or greater (south side) with respect to XZ plane.

The data relay satellite 301, having the first optical communication terminal 10a placed on −Z side on the south face and having the second optical communication terminal 10b placed on +Z side on the south face, ensures the communication visual fields by changing heights thereof in Y axis direction.

Equipment with the two optical communication terminals produces an effect in that communication with a plurality of spacecrafts such as a gateway and a lunar exploration satellite can be carried out. Further, loss of functions resulting from failure is avoided by a redundant configuration.

Though ensuring of a broad communication visual field is problematic, there are an upper limit of an Elevation visual field range and the dead zone in the earth direction in Azimuth. Therefore, the communication visual fields of the two optical communication terminals are ensured by formation of a raising structure with use of the dead zone of the first optical communication terminal and raising of the second optical communication terminal in Y axis direction.

In Embodiments 1 to 3 described above, configurations of systems and devices such as the satellite watching system, the infrastructure satellite, the watching satellite, the communication device, and the watching center do not have to be the configurations as in the above-described embodiments. Any configurations may be employed for the systems and the devices as long as the functions described in the embodiments described above can be implemented with the configurations.

Further, a plurality of portions or working examples of Embodiments 1 to 3 may be implemented in combination. Alternatively, a portion or a working example in these embodiments may be implemented. Otherwise, these embodiments may be implemented generally or partially in combination in any manner.

In Embodiments 1 to 3, namely, free combination of the embodiments, modification of any component of the embodiments, or omission of any component of the embodiments may be fulfilled.

Incidentally, the embodiments described above intrinsically adduce preferred examples and are not intended for limiting the scope of the present disclosure, the scopes of applications of the present disclosure, and the scopes of uses of the present disclosure. The embodiments described above may be modified in various manners as appropriate.

### REFERENCE SIGNS LIST

10: optical communication terminal; 10a: first optical communication terminal; 10b: second optical communication terminal; 30: satellite; 310: satellite control device; 33: propulsion device; 34: attitude control device; 35: power supply device; 32: communication device; 41: first communication terminal; 42: second communication terminal; 43: third communication terminal; 44: fourth communication terminal; 301: data relay satellite; 302: solar cell paddle; 401: communication satellite; 403: meteorological satellite; 409: lunar and planetary exploration satellite; 410: resource exploration satellite; 411: freighter; 412: cislunar data relay satellite; 419: gateway; 421: optical watching satellite; 422: infrared watching satellite; 423: radio watching satellite; 424: service satellite; 51: critical infrastructure; 501: infrastructure satellite cluster; 511: infrastructure satellite; 52: watching satellite cluster; 521: watching satellite; 53: watching center; 531: watching information server; 54: ground installation; 64: transmission/reception switching device; 65: bidirectional communication standard terminal; 590: watching information; 601: exploration satellite cluster; 500: satellite watching system; 510: satellite information transmission system; 710: watching management unit; 720: storage unit; 910: processor; 921: memory; 922: auxiliary storage device; 930: input interface; 940: output interface; 941: display equipment; 950: communication device

1. A satellite watching system comprising:
a critical infrastructure including an infrastructure satellite cluster including infrastructure satellites to fly in a cislunar space that is a space between the moon and the earth or beyond the moon, to form social infrastructure, and to put a service into practice;
a watching satellite cluster including watching satellites to fly between the moon and the earth to monitor the critical infrastructure and to provide an on-orbit service;
a ground installation installed on ground to exchange information with the infrastructure satellite cluster and to operate the infrastructure satellite cluster; and
a watching center installed on the ground to exchange information with the watching satellite cluster, wherein
the infrastructure satellite cluster includes a cislunar data relay satellite to relay communication between a space object flying in a near-moon orbit and the ground, and
when the watching satellite passes through a vicinity of a lunar and planetary exploration satellite having a consolidated environment of communication with the cislunar data relay satellite, as the critical infrastructure, the watching satellite exchanges watching information with the lunar and planetary exploration satellite, which exchanges the watching information with the watching center via the cislunar data relay satellite.

2. A satellite watching system comprising:
a critical infrastructure including an infrastructure satellite cluster including infrastructure satellites to fly in a cislunar space that is a space between the moon and the earth or beyond the moon, to form social infrastructure, and to put a service into practice;
a watching satellite cluster including watching satellites to fly between the moon and the earth to monitor the critical infrastructure and to provide an on-orbit service;
a ground installation installed on ground to exchange information with the infrastructure satellite cluster and to operate the infrastructure satellite cluster; and
a watching center installed on the ground to exchange information with the watching satellite cluster, wherein
the infrastructure satellite cluster includes a cislunar data relay satellite to relay communication between a space object flying in a near-moon orbit and the ground,
the critical infrastructure includes a cislunar freighter that has a consolidated environment of communication with the cislunar data relay satellite and that transports commodities to the cislunar space,
the cislunar freighter transports a watching satellite to the cislunar space and thereafter releases the watching satellite, and
the watching satellite exchanges watching information with the cislunar freighter, which exchanges the watching information with the watching center via the cislunar data relay satellite.

3. A satellite watching system comprising:
a critical infrastructure including an infrastructure satellite cluster including infrastructure satellites to fly in a cislunar space that is a space between the moon and the earth or beyond the moon, to form social infrastructure, and to put a service into practice;
a watching satellite cluster including watching satellites to fly between the moon and the earth to monitor the critical infrastructure and to provide an on-orbit service;
a ground installation installed on ground to exchange information with the infrastructure satellite cluster and to operate the infrastructure satellite cluster; and
a watching center installed on the ground to exchange information with the watching satellite cluster, wherein
the infrastructure satellite cluster includes a cislunar data relay satellite to relay communication between a space object flying in a near-moon orbit and the ground,
when the watching satellite passes through a vicinity of a lunar and planetary exploration satellite having a consolidated environment of communication with the cislunar data relay satellite, as the critical infrastructure, the watching satellite exchanges watching information with the lunar and planetary exploration satellite, which exchanges the watching information with the watching center via the cislunar data relay satellite,
each satellite in the infrastructure satellite cluster and the watching satellite cluster includes a bidirectional communication standard terminal with a transmission/reception switching device to implement reception and transmission by switching between a receiving function and a transmitting function, and
the watching center operates the transmission/reception switching device, based on a data amount α of commands that are transmitted to the watching satellite and a data amount β of watching data and telemetry data that are received from the watching satellite, so that a ratio between reception time and transmission time of the watching satellite becomes α versus β and carries out exchange of the information with the watching satellite cluster via the lunar and planetary exploration satellite and the cislunar data relay satellite.

4. A satellite information transmission system comprising:
a critical infrastructure including an infrastructure satellite cluster including infrastructure satellites to fly in a cislunar space that is a space between the moon and the earth or beyond the moon, to form social infrastructure, and to put a service into practice; and
a ground installation installed on ground to exchange information with the infrastructure satellite cluster and to operate the infrastructure satellite cluster, wherein
the infrastructure satellite cluster includes a cislunar data relay satellite to relay communication between a space object flying in a near-moon orbit and the ground,
the infrastructure satellite includes a bidirectional communication standard terminal with a transmission/reception switching device that has communication compatibility with a gateway in a vicinity of the moon and that is to implement reception and transmission by switching between a receiving function and a transmitting function, and
the ground installation operates the transmission/reception switching device, based on a data amount α of commands that are transmitted to a first infrastructure satellite and a data amount β of mission data and telemetry data that are received from the first infrastructure satellite, so that a ratio between reception time and transmission time of the first infrastructure satellite becomes α versus β and carries out exchange of information with the first infrastructure satellite cluster via the cislunar data relay satellite.

5. The watching satellite to be used for the satellite watching system according to claim 3, comprising:
the bidirectional communication standard terminal, wherein
transmission/reception time ratio that is a ratio between reception time and transmission time is controlled by a command.

6. The infrastructure satellite to be used for the satellite watching system according to claim 3, the infrastructure satellite comprising:
the bidirectional communication standard terminal, wherein
transmission/reception time ratio that is a ratio between reception time and transmission time is controlled by a command.

7. The bidirectional communication standard terminal to be used for the satellite watching system according to claim 3.

8. The watching center to be used for the satellite watching system according to claim 1, the watching center comprising:
a watching information server, wherein
the watching information is exchanged via the ground installation.

9. A satellite watching system comprising:
a critical infrastructure including an infrastructure satellite cluster including infrastructure satellites to fly in a cislunar space that is a space between the moon and the earth or beyond the moon, to form social infrastructure, and to put a service into practice;
a watching satellite cluster including watching satellites to fly between the moon and the earth to monitor the critical infrastructure and to provide an on-orbit service;
a ground installation installed on ground to exchange information with the infrastructure satellite cluster and to operate the infrastructure satellite cluster; and
a watching center installed on the ground to exchange information with the watching satellite cluster, wherein
the infrastructure satellite cluster includes a cislunar data relay satellite to relay communication between a space object flying in a near-moon orbit and the ground and a gateway in a vicinity of the moon for which an environment of communication with the cislunar data relay satellite has been consolidated,
the infrastructure satellite includes a bidirectional communication standard terminal with a transmission/reception switching device that has communication compatibility with the gateway and that is to implement reception and transmission by switching between a receiving function and a transmitting function and a communication terminal to communicate with the watching satellite,
the watching satellite includes a communication terminal to communicate with the infrastructure satellite, and
exchange of the information between the watching satellite cluster and the watching center is carried out via the infrastructure satellite, the cislunar data relay satellite, and the ground installation.

10. The watching center to be used for the satellite watching system according to claim 9, the watching center comprising:
a watching information server, wherein
the watching information is exchanged via the cislunar data relay satellite and the ground installation.

11. A data relay satellite to relay communication between a space object flying in a near-moon orbit and a ground installation, wherein
the data relay satellite flies in a stationary orbit,
with X axis of a satellite coordinate system in an east-face traveling direction, Y axis in a south direction, and Z axis in an earth direction,
a solar cell paddle has a north face (−Y) one wing configuration,
an optical communication terminal is mounted on a south face (+Y), and
a communication visual field including Azimuth of ±170 deg with respect to a counter-earth direction (−Z axis) around a north-south axis (Y axis) and a communication visual field with Elevation of −25 deg or greater (north side) and Elevation of 36 deg or greater (south side) with respect to XZ plane are ensured.

12. A data relay satellite to relay communication between a space object flying in a near-moon orbit and a ground installation, wherein
the data relay satellite flies in a stationary orbit,
with X axis of a satellite coordinate system in an east-face traveling direction, Y axis in a south direction, and Z axis in an earth direction,
a solar cell paddle has a north face (−Y) one wing configuration,
an optical communication terminal is mounted on a south face (+Y),
the data relay satellite includes a first optical communication terminal and a second optical communication terminal to ensure a communication visual field including Azimuth of ±170 deg with respect to a counter-earth direction (−Z axis) around a north-south axis (Y axis) and a communication visual field with Elevation of −25 deg or greater (north side) and Elevation of 36 deg or greater (south side) with respect to XZ plane,
the first optical communication terminal is placed on −Z side on the south face, and the second optical communication terminal is placed on +Z side on the south face, and
the communication visual fields are ensured by change in heights thereof in Y axis direction.

13. The cislunar data relay satellite to be used for the satellite watching system according to claim 1.

14. A satellite information transmission system comprising:
a critical infrastructure including an infrastructure satellite cluster including infrastructure satellites to fly in a cislunar space that is a space between the moon and the earth or beyond the moon, to form social infrastructure, and to put a service into practice; and
a ground installation installed on ground to exchange information with the infrastructure satellite cluster and to operate the infrastructure satellite cluster, wherein
the infrastructure satellite cluster includes a cislunar data relay satellite to relay communication between a space object flying in a near-moon orbit and the ground,
the critical infrastructure includes a cislunar freighter that has a consolidated environment of communication with the cislunar data relay satellite and that transports commodities to the cislunar space,
the cislunar freighter transports the infrastructure satellite to the cislunar space and thereafter releases the infrastructure satellite, and
the infrastructure satellite exchanges satellite information with the cislunar freighter, and the cislunar freighter exchanges the satellite information with the ground installation via the cislunar data relay satellite.

15. The freighter to be used for the satellite watching system according to claim 2.
